(19) United States
(12) Patent Application Publication
(10) Pub. No.: US 2009/0150150 A1
(43) Pub. Date: Jun. 11, 2009

(54) SYSTEM AND METHOD FOR CONTROLLING ACCESS TO A HANDHELD DEVICE BY VALIDATING VOICE SOUNDS

(75) Inventor: KWANG-CHUNG YANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/133,394

(22) Filed: Jun. 5, 2008

(30) Foreign Application Priority Data
Dec. 6, 2007 (CN) 200710202879.8

(51) Int. Cl. G10L 17/00

(52) U.S. Cl. 704/246; 704/E17.001

(57) ABSTRACT

A method for controlling access to a handheld device (10) by validating voice sounds includes: setting voice characteristics acceptable error margin; storing voice characteristics of the original voice sounds of a user in a memory (12) of the handheld; recording validation voice sounds of the user through a microphone (11) in the handheld device; detecting voice characteristics of the validation voice sounds; determining whether the voice characteristics of the validation voice sounds matches the voice characteristics of the original voice sounds in the memory by comparing a difference between the voice characteristics of the validation voice sounds and the voice characteristics of the original voice sounds is within the voice characteristics acceptable error margin; and allowing the user to access the handheld device if the voice characteristics of the validation voice sounds matches the voice characteristics of the original voice sounds.

### BACKGROUND OF THE INVENTION

1. Field of the Invention

The present invention generally relates to systems and methods for controlling access to electronic devices, and particularly to a system and method for controlling access to a handheld device by validating voice sounds.

2. Description of Related Art

Generally, a handheld device is a pocket-sized computing device, which typically includes a small visual display for output and a miniature keyboard or touch screen for input. Handheld devices may be mobile phones, personal digital assistants (PDAs), handheld game players, digital cameras, etc.

Handheld devices are popular because of their multi-function services and other conveniences. Because handheld devices are used for storing personal information and are carried as a personal effect they are vulnerable to thief and subsequent loss of information. In addition to preventing thief, it is also necessary to insure information security of the handheld device. A conventional method for ensuring the information security of the handheld device is to set an access password for the handheld device. However most users tends to set easy to remember password which may easily be cracked.

Accordingly, what is needed is a system and method for providing high security with simple access to a handheld device.

### SUMMARY

A system for controlling access to a handheld device by validating voice sounds is provided. The handheld device includes a memory, a voice characteristic setting module, a recording module, a voice characteristic detecting module, a determining module, and an access controlling module. The memory is configured for storing voice characteristics of original voice sounds of a user. The voice characteristic setting module is configured for setting voice characteristics acceptable error margin. The recording module is configured for recording validation voice sounds of the user through a microphone in the handheld device. The voice characteristic detecting module is configured for detecting voice characteristics of the validation voice sounds. The determining module is configured for determining whether the voice characteristics of the validation voice sounds matches the voice characteristics of the original voice sounds in the memory by comparing that a difference between the voice characteristics of the validation voice sounds and the voice characteristics of the original voice sounds is within the voice characteristics acceptable error margin. The access controlling module is configured for allowing the user to access the handheld device if the voice characteristics of the validation voice sounds matches the voice characteristics of the original voice sounds.

Other systems, methods, features, and advantages will be or become apparent to one skilled in the art upon examination of the following drawings and detailed description.

### BRIEF DESCRIPTION OF THE DRAWINGS

FIG. 1 is a block diagram of a system for controlling access to a handheld device by validating voice sounds in accordance with an exemplary embodiment of the present invention. and

FIG. 2 is a flowchart of a method for controlling access to a handheld device by validating voice sounds in accordance with the exemplary embodiment.

### DETAILED DESCRIPTION OF THE EMBODIMENTS

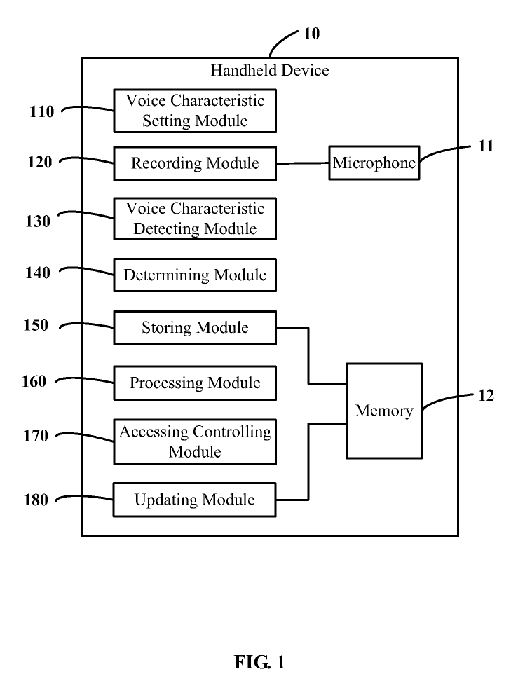

FIG. 1 is a block diagram of a system for controlling access to a handheld device by validating voice sounds in accordance with an exemplary embodiment of the present invention. The handheld device 10 typically includes a microphone 11, a memory 12, a voice characteristic setting module 110, a recording module 120, a voice characteristic detecting module 130, a determining module 140, a storing module 150, a processing module 160, an access controlling module 170 and an updating module 180.

The handheld device 1 may be a mobile phone, a personal digital assistant (PDA), a handheld game player, a digital camera, a palm computer, or other portable electronic devices.

The microphone 11 is configured for recording original voice sounds and validation voice sounds. The memory 12 may be an internal memory card or an external memory card. The external memory card typically includes a smart media card (SMC), a secure digital card (SDC), a compact flash card (CFC), a multi media card (MMC), a memory stick (MS), a extreme digital card (XDC), and a trans flash card (TFC).

The voice characteristic setting module 110 is configured for setting a standard range of the voice characteristics and voice characteristics acceptable error margin. The voice characteristics typically include a voice frequency and a voice intensity. For example, the standard range of the voice frequency may be set as 100 hertz (HZ) to 1000 Hz, the standard range of the voice intensity may be set as 30 decibel (dB) to 80 dB.

The recording module 120 is connected to the microphone 11, and configured for recording original voice sounds of a user through the microphone 11.

The voice characteristic detecting module 130 is configured for detecting voice characteristics of the original voice sounds. The voice characteristics of the original voice sounds, which are detected by the voice characteristic detecting module 130, include a voice frequency and a voice intensity. For example, the voice frequency of the original voice sounds detected by the voice characteristic detecting module 130 may be 210 Hz, the voice intensity of the original voice sounds detected by the voice characteristic detecting module 130 may be 45 dB.

The determining module 140 is configured for determining whether the voice characteristics of the original voice sounds fall within the standard range of the voice characteristics. If the voice characteristics of the original voice sounds fall within the standard range of the voice characteristics, the voice characteristics of original voice sounds are qualified to be validation codes for the handheld device 10; otherwise, if the voice characteristics of the original voice sounds are out of the standard range of the voice characteristics, the voice characteristics of original voice sounds are unqualified to be the validation codes for the handheld device 10. For example, if the voice intensity of the original voice sounds is lower than 30 dB, or if the voice frequency of the original voice sounds is lower than 100 Hz, the voice characteristics of original voice sounds are unqualified to be the validation codes for the handheld device 10.

The storing module 150 is configured for storing the voice characteristics of the original voice sounds into the memory 12 as the validation codes for the handheld device 10.

The recording module 120 is further configured for recording validation voice sounds of the user through the microphone 11 if the user needs to access the handheld device 10.

The processing module 160 is configured for processing the validation voice sounds. The processing of the validation voice sounds includes filtering noise and amplifying signals.

The voice characteristic detecting module 130 is further configured for detecting voice characteristics of the validation voice sounds. The voice characteristics of the validation voice sounds typically include a voice frequency and a voice intensity.

The determining module 140 is further configured for determining whether the voice characteristics of the validation voice sounds matches the voice characteristics of the original voice sounds in the memory 12 by comparing that the difference between the voice characteristics of the validation voice sounds and the voice characteristics of the original voice sounds is within the voice characteristics acceptable error margin. Specifically, if the difference between the voice characteristics of the validation voice sounds and the voice characteristics of the original voice sounds fall within the voice characteristics acceptable error margin, the voice characteristics of the validation voice sounds is considered as a match with the voice characteristics of the original voice sounds; otherwise, if the difference between the voice characteristics of the validation voice sounds and the voice characteristics of the original voice sounds are outside of the voice characteristics acceptable error margin, the voice characteristics of the validation voice sounds is not considered as a match with the voice characteristics of the original voice sounds.

The access controlling module 170 is configured for allowing the user to access the handheld device 10 if the voice characteristics of the validation voice sounds matches the voice characteristics of the original voice sounds.

The updating module 180 is configured for updating the voice characteristics of the original voice sounds in the memory 12 with the voice characteristics of the validation voice sounds. In the exemplary embodiment, the updating module 180 deletes the voice characteristics of the original voice sounds after inputting the new voice characteristics of the new validation voice sounds into the memory 12. Then the new voice characteristics of the new validation voice sounds input into the memory 12 are set as the validation codes for controlling access the handheld device 10. In other embodiments, the updating module 180 may keep the voice characteristics of the original voice sounds with the new voice characteristics of the new validation voice sounds input into the memory 12. Under this condition, the new voice characteristics of the new validation voice sounds and the voice characteristics of the original voice sounds are both set as validation codes for controlling access the handheld device 10.

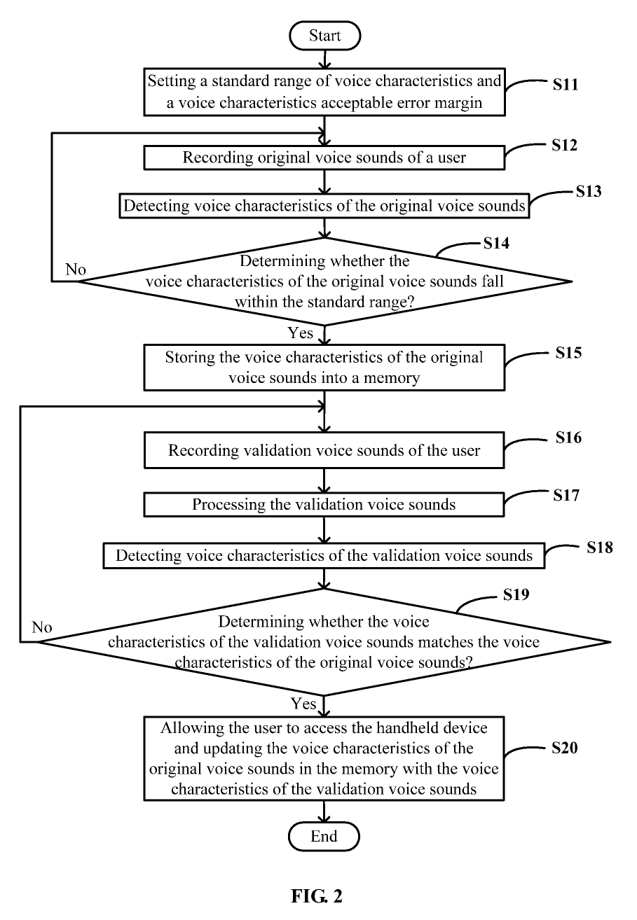

FIG. 2 is a flowchart of a method for controlling access to a handheld device by validating voice sounds in accordance with the exemplary embodiment.

In step S11, the voice characteristic setting module 110 sets the standard range of the voice characteristics and the voice characteristics acceptable error margin. The voice characteristics typically include the voice frequency and the voice intensity.

In step S12, the recording module 120 records the original voice sounds of the user through the microphone 11.

In step S13, the voice characteristic detecting module 130 detects the voice characteristics of the original voice sounds.

In step S14, the determining module 140 determines whether the voice characteristics of the original voice sounds fall within the standard range of the voice characteristics.

In step S15, if the voice characteristics of the original voice sounds fall within the standard range of the voice characteristics, the storing module 150 stores the voice characteristics of the original voice sounds into the memory 12 as the validation codes for the handheld device 10.

In step S16, the recording module 120 records the validation voice sounds of the user through the microphone 11 if the user need to access the handheld device 10.

In step S17, the processing module 160 processes the validation voice sounds. The processing of the validation voice sounds includes filtering noise and amplifying signals.

In step S18, the voice characteristic detecting module 130 detects voice characteristics of the validation voice sounds. The voice characteristics of the validation voice sounds typically include a voice frequency and a voice intensity.

In step S19, the determining module 140 determines whether the voice characteristics of the validation voice sounds matches the voice characteristics of the original voice sounds in the memory 12 by comparing that the difference between the voice characteristics of the validation voice sounds and the voice characteristics of the original voice sounds is within the voice characteristics acceptable error margin. Specifically, if the difference between the voice characteristics of the validation voice sounds and the voice characteristics of the original voice sounds fall within the voice characteristics acceptable error margin, the voice characteristics of the validation voice sounds is considered as a match with the voice characteristics of the original voice sounds; otherwise, if the difference between the voice characteristics of the validation voice sounds and the voice characteristics of the original voice sounds are outside of the voice characteristics acceptable error margin, the voice characteristics of the validation voice sounds is not considered as a match with the voice characteristics of the original voice sounds.

In step S20, if the voice characteristics of the validation voice sounds matches the voice characteristics of the original voice sounds, the access controlling module 170 allows the user to access the handheld device 10 and the updating module 180 updates the voice characteristics of the original voice sounds in the memory 12 with the voice characteristics of the validation voice sounds, and the procedure ends.

If the voice characteristics of the original voice sounds are out of the range of the voice characteristic standards in step S14, the voice characteristics of original voice sounds are not qualified to be the validation codes for the handheld device 10, and the procedure returns to the step S12 again.

If the voice characteristics of the validation voice sounds does not match the voice characteristics of the original voice sounds in step S19, access to the handheld device 10 is not allowed, and the procedure returns to the step S16.

It should be emphasized that the above-described embodiments of the exemplary embodiments are merely possible examples of implementations, merely set forth for a clear understanding of the principles of the invention. Many variations and modifications may be made to the above-described exemplary embodiment without departing substantially from the spirit and principles of the invention. All such modifications and variations are intended to be included herein within the scope of this disclosure and the above-described exemplary embodiment and protected by the following claims.

What is claimed is:

1. A system for controlling access to a handheld device by validating voice sounds, the handheld device comprising:
a memory for storing voice characteristics of original voice sounds of a user;
a voice characteristic setting module configured for setting voice characteristics acceptable error margin;
a recording module configured for recording validation voice sounds of the user through a microphone in the handheld device;
a voice characteristic detecting module configured for detecting voice characteristics of the validation voice sounds;
a determining module configured for determining whether the voice characteristics of the validation voice sounds matches the voice characteristics of the original voice sounds in the memory by comparing that a difference between the voice characteristics of the validation voice sounds and the voice characteristics of the original voice sounds is within the voice characteristics acceptable error margin; and
an access controlling module configured for allowing the user to access the handheld device if the voice characteristics of the validation voice sounds matches the voice characteristics of the original voice sounds.

2. The system according to claim 1, wherein the determining module is further configured for determining that the voice characteristics of the validation voice sounds is considered as a match with the voice characteristics of the original voice sounds in the memory if the difference between the voice characteristics of the validation voice sounds and the voice characteristics of the original voice sounds fall in the voice characteristics acceptable error margin, and determining that the voice characteristics of the validation voice sounds is not considered as a match with the voice characteristics of the original voice sounds in the memory if the difference between the voice characteristics of the validation voice sounds and the voice characteristics of the original voice sounds are outside of the voice characteristics acceptable error margin.

3. The system according to claim 1, wherein the handheld device further comprises a processing module for processing the validation voice sounds.

4. The system according to claim 1, wherein the handheld device further comprises an updating module for updating the voice characteristics of the original voice sounds in the memory with the voice characteristics of the validation voice sounds.

5. The system according to claim 1, wherein the handheld device further comprises a storing module, wherein:
the voice characteristic setting module is further configured for setting a standard range of the voice characteristic;
the recording module is further configured for recording original voice sounds of the user through the microphone;
the voice characteristic detecting module is further configured for detecting voice characteristics of the original voice sounds;
the determining module is further configured for determining whether the voice characteristics of the original voice sounds fall within the standard range; and
the storing module is configured for storing the voice characteristics of the original voice sounds into the memory as validation codes for the handheld device, if the voice characteristics of the original voice sounds fall within the standard range.

6. The system according to claim 5, wherein the voice characteristics of the original voice sounds comprise a voice frequency and a voice intensity.

7. A method for controlling access to a handheld device by validating voice sounds, the method comprising:
setting voice characteristics acceptable error margin;
storing voice characteristics of the original voice sounds of a user in a memory of the handheld;
recording validation voice sounds of the user through a microphone in the handheld device;
detecting voice characteristics of the validation voice sounds;
determining whether the voice characteristics of the validation voice sounds matches the voice characteristics of the original voice sounds in the memory by comparing that a difference between the voice characteristics of the validation voice sounds and the voice characteristics of the original voice sounds is within the voice characteristics acceptable error margin; and
allowing the user to access the handheld device if the voice characteristics of the validation voice sounds matches the voice characteristics of the original voice sounds.

8. The method according to claim 7, wherein the storing step further comprising:
setting a standard range of the voice characteristics;
recording original voice sounds of the user through the microphone;
detecting voice characteristics of the original voice sounds;
determining whether the voice characteristics of the original voice sounds fall within the standard range; and
storing the voice characteristics of the original voice sounds into the memory if the voice characteristics of the original voice sounds fall within the standard range.

9. The method according to claim 7, wherein the determining step further comprising:
determining that the voice characteristics of the validation voice sounds is considered as a match with the voice characteristics of the original voice sounds in the memory if the difference between the voice characteristics of the validation voice sounds and the voice characteristics of the original voice sounds fall in the voice characteristics acceptable error margin; and
determining that the voice characteristics of the validation voice sounds is not considered as a match with the voice characteristics of the original voice sounds in the memory if the difference between the voice characteristics of the validation voice sounds and the voice characteristics of the original voice sounds are outside of the voice characteristics acceptable error margin.

10. The method according to claim 7, wherein the method further comprising:
updating the voice characteristics of the original voice sounds in the memory with the voice characteristics of the validation voice sounds after the accessing step.

11. The method according to claim 7, wherein the method further comprising:
processing the validation voice sounds before the detecting step.

12. The method according to claim 11, wherein the processing of the validation voice sounds comprises filtering noise and amplifying signals.
